(19) United States
(12) Patent Application Publication
(10) Pub. No.: US 2010/0308216 A1
(43) Pub. Date: Dec. 9, 2010

(54) FAIMS Ion Mobility Spectrometer With Multiple Doping

(76) Inventors: Alastair Clark, Dustable (GB); Bruce Alec Colin Grant, London (GB); William Angus Munro, Watford (GB)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/446,703

(22) PCT Filed: Oct. 30, 2007
(86) PCT No.: PCT/GB07/04113

§ 371 Date: Apr. 22, 2009

(51) Int. Cl. H01J 49/26; H01J 49/04

(52) U.S. Cl. 250/282; 250/288

(57) ABSTRACT

A FAIMS ion mobility spectrometer is arranged so that the analyte is subject to different ion chemistries at different locations along the spectrometer. Different dopants, or different concentrations of dopants or water vapor are admitted at various locations, such as at the inlet, between the inlet and the ionizer between the ionizer and the gate, between the gate and the FAIMS parallel plates, through an opening in one of the plates, or between the end of the plates and the detector.

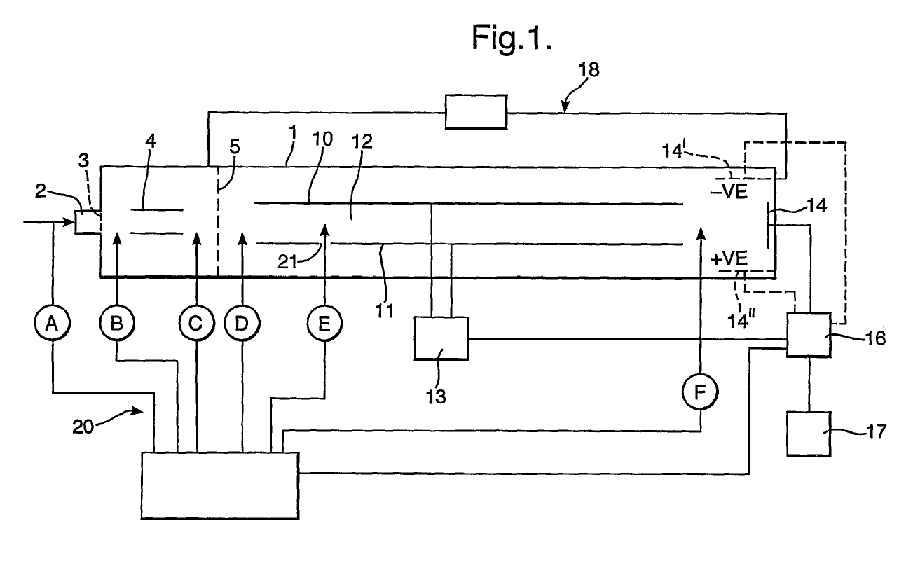

This invention relates to apparatus detection apparatus of the kind including a sample inlet, an ionisation arrangement for ionising molecules of analyte substance entering the apparatus via the inlet, and an asymmetric field region in which the ions are subject to an asymmetric field for detection.

The invention is more particularly concerned with detecting small quantities of gases and vapours.

Field asymmetric ion mobility spectrometers (FAIMS) or differential mobility spectrometers (DMS) have a filter region where an electrical field is produced transverse to direction of ion flow. By appropriately setting the electric field, certain ion species can be selected to flow through the filter for detection. It can, however, be difficult reliably to detect certain chemicals using FAIMS type apparatus

It is an object of the present invention to provide an alternative detection apparatus and method.

According to one aspect of the present invention there is provided detection apparatus of the above-specified kind, characterised in that the apparatus is arranged to admit at least one chemical additive at a plurality of different locations along the apparatus such that the sample is subject to different ion chemistries at different locations in the apparatus.

The chemical additives admitted at the different locations may be of different substances or of different concentrations. The chemical additive may be water vapour or a dopant. The chemical additive may be added at at least two of the following locations: at the sample inlet; between the inlet and the ionisation arrangement; between the ionisation arrangement and the asymmetric field region; between the ends of the asymmetric field region; and between the asymmetric field region and a detector. The apparatus may include a parallel plate arrangement by which the asymmetric field is established, the chemical additive being added at a location between the ends of the parallel plate arrangement.

According to another aspect of the present invention there is provided detection apparatus including a sample inlet, an ionisation arrangement for ionising molecules of analyte substance entering the apparatus via the inlet, and an asymmetric field region in which the ions are subject to an asymmetric field for detection, characterised in that the apparatus is arranged to create ions in one chemistry and move ions to a different chemistry.

According to a further aspect of the present invention there is provided a method of detecting an analyte substance including the steps of introducing molecules of the substance via an inlet, ionising molecules of the substance, and admitting the ions to a region of a transverse electrical field so as to separate different ion species from one another, characterised in that a chemical additive is admitted to different locations so that analyte is subject to different ion chemistries at different locations, and detecting ion species.

According to a fifth aspect of the present invention there is provided detection apparatus including a sample inlet, an ionisation arrangement for ionising molecules of analyte substance entering the apparatus via the inlet, and an asymmetric field region in which the ions are subject to an asymmetric field for detection, characterised in that the apparatus includes an arrangement for admitting at least one chemical additive to a location intermediate the ends of the asymmetric field region.

The asymmetric field region preferably has two parallel plate arrangements extending parallel to the ion flow direction and the arrangement for admitting the chemical additive preferably includes an opening through at least one of the plate arrangements intermediate the ends of the plate arrangement.

Detection apparatus and its method of operation, in accordance with the present invention, will now be described, by way of example, with reference to the accompanying drawing, which shows the apparatus schematically.

The apparatus includes an elongate housing 1 with a sample inlet 2 at its left-hand end covered by a membrane 3. The membrane 3 allows molecules of the analyte substance of interest to enter the housing 1 but prevents some larger molecules, particles and the like entering. Alternatively, the inlet could have any other conventional means for restricting entry, such as a pinhole inlet, a capillary inlet or the like. The interior of the housing 1 is at substantially atmospheric pressure. Ions of the analyte flow along the housing 1 generally from left to right.

An ionisation source 4 is located immediately adjacent the inlet 2. This may be of any conventional kind such as a radioactive source, a corona discharge device, a photoionisation source or the like. As shown, the ionisation source 4 is a corona discharge device. To the right of the ionisation source 4 is an electrostatic gate 5, such as a Bradbury Nielson gate, by which ions are blocked or enabled to flow to the right further along the housing 1. To the right of the gate 5, and downstream in the direction of ion flow, are mounted two FAIMS plate arrangements 10 and 11. The plate arrangements 10 and 11 are flat, parallel plates, closely spaced and extending longitudinally of the housing 1 and generally parallel to the ion flow direction. Instead of flat plates it would be possible to use two concentric cylindrical FAIMS plates. The plate arrangements 10 and 11 are connected to a conventional FAIMS power source 13. The power source 13 applies an asymmetric alternating voltage across the two plate arrangements 10 and 11 superimposed on a dc compensation voltage, in the usual way. At the far end of the housing 1 remote from the inlet 2, and beyond the right-hand end of the FAIMS plate arrangements 10 and 11, is a detector plate 14 positioned centrally with respect to the gap 12 between the two plates. The detector plate 14 is connected to an amplifier and processor 16 responsive to the charge on the plate to provide an output to a display or other utilisation means 17 indicative of the identity of the analyte substance sampled. A gas flow circuit 18 is connected to flow clean dry air through the housing 1 in the usual way.

Alternatively, instead of having a single detector plate the apparatus could have two detector plates 14′ and 14″ as shown by the broken lines in the drawing. These plates 14′ and 14″ are mounted at the sides of the apparatus, on opposite sides of the gap 12. Voltages are applied to the plates 14′ and 14″ so that they are at a negative and positive potential respectively and thereby collect positive and negative ions respectively.

As so far described, the apparatus is conventional.

The apparatus differs from conventional FAIMS systems in that it has provision to establish different ion chemistries at different locations along the apparatus. This may be achieved by adding one or more chemical additives in the form of a gas or vapour to the apparatus at least at two different locations.

The drawing illustrates a chemical additive system 20 connected to the apparatus at six different alternative locations along its length, labelled “A” to “F”.

The first location “A” is at the inlet 2 so that the additive is added with the analyte substance before the membrane 3.

The second location “B” is within the housing 1, after the membrane 3 and before the ionisation source 4.

The third location “C” is between the ionisation source 4 and the gate 5.

The fourth location “D” is after the gate 5 and before the left-hand end of the FAIMS plates 10 and 11.

The fifth location “E” is through an opening 21 in one of the FAIMS plates 11 at some point along its length. There could be more than one admittance points along the FAIMS plates 10 and 11. The opening may be a simple opening in the plate 11. Alternatively, the plate arrangements could include several separate plates spaced from one another along the length of the apparatus so that the chemical additive could be added via any of these openings.

The sixth location “F” is at the downstream end of the FAIMS plates 10 and 11, before the detector plate 14.

Any two or more of these locations “A” to “F” could be used.

The additive supplied could take various different forms such that the ion chemistry in the two regions to which the additive is supplied is different one from the other. For example, the additive could be arranged to establish different levels of humidity at two different locations such as by supplying an additive in the form of water vapour (to increase humidity) or dried air (to decrease humidity). Additives could take the form of various dopant chemicals such as, for example, ammonia, acetone, methanol, benzene, toluene, chlorine compounds such as dichloromethane, or bromine compounds such as dibromomethane. Other dopants could be used. The concentration of the additives can be selectively varied, such as in response to the detected ions. In this respect, the levels of chemicals may be switched between different discrete levels.

In operation, analyte molecules in sample air pass through the membrane 3 at the inlet 2 to the ionisation source 4 where the molecules are ionised. The ion species produced continue flowing to the right under the effect of the flow of gas from the gas flow circuit 18 and, or alternatively, an electric field established by charged plates (not shown). The charge on the two FAIMS plates 10 and 11 may be such as to attract the ion species into the gap 12, although this is not essential. The ions species move along the gap 12 under the combined effect of the electrostatic field and the gas flow. The applied FAIMS field acts to separate out the different ion species from one another and the dc compensation voltage applied to the plates 10 and 11 is selected such that some at least of the ion species that are not of interest are attracted to one or other of the plates where they are neutralised. The remaining ion species flow along the entire length of the gap 12 without contacting the FAIMS plates 10 and 11 and are collected by the detector plate 14. Other FAIMS or DMS arrangements could be used. During passage along the apparatus the analyte substance or its ions are exposed to two or more different ion chemistries

By exposing the ions, or the pre-ionized sample molecules, to two or more different ion chemistries at different locations, it is possible to improve detection of certain analyte substances. Also, controlling the chemistry within the length of FAIMS electrodes can be used to improve detection independently of modification of the chemistry in other parts of the apparatus.

1. A detection apparatus comprising:
a sample inlet;
an ionization arrangement for ionizing molecules of an analyte substance entering the detection apparatus via the sample inlet into analyte ions; and
an asymmetric field region in which the analyte ions are subject to an asymmetric field for detection;
wherein the detection apparatus is arranged and configured to admit at least one chemical additive at a plurality of different locations along the apparatus such that the analyte substance is subject to different ion chemistries at different locations in the apparatus.

2. A detection apparatus as defined in claim 1, wherein the at least one chemical additive admitted at the plurality of different locations comprises a plurality of different substances.

3. A detection apparatus as defined in claim 1, wherein the at least one chemical additive admitted at the different locations comprises at least two chemical additives of different concentrations.

4. A detection apparatus as defined in claim 1, wherein the chemical additive comprises water vapor.

5. A detection apparatus as defined in claim 1, wherein the chemical additive comprises a dopant.

6. A detection apparatus as defined in claim 1, additionally comprising:
a detector located on an opposite end of the asymmetric field region from the ionization arrangement;
wherein the chemical additive is added at at least two of the locations from the group consisting of:
a location at the sample inlet;
a location intermediate the sample inlet and the ionization arrangement;
a location intermediate the ionization arrangement and the asymmetric field region;
a location intermediate opposite ends of the asymmetric field region; and
a location intermediate the asymmetric field region and the detector.

7. A detection apparatus as defined in claim 1, additionally comprising:
a parallel plate arrangement by which the asymmetric field is established, wherein the chemical additive is added at a location between opposite ends of the parallel plate arrangement.

8. A detection apparatus comprising:
a sample inlet;
an ionization arrangement for ionizing molecules of an analyte substance entering the detection apparatus via the sample inlet into analyte ions; and
an asymmetric field region in which the analyte ions are subject to an asymmetric field for detection;
wherein the detection apparatus is arranged and configured to create ions in one chemistry and move ions to a different chemistry.

9. A method of detecting an analyte substance comprising the steps of:
introducing molecules of the analyte substance to a detection apparatus via an inlet;
ionizing molecules of the analyte substance in the detection apparatus into analyte ions; and
admitting the analyte ions to a region of a transverse electrical field that is arranged and configured in the detection apparatus to separate different ion species from one another;
admitting a chemical additive to a plurality of different locations in the detection apparatus so that the analyte substance is subject to different ion chemistries at different in the detection apparatus; and
detecting ion species in the detection apparatus.

10. A detection apparatus comprising:
a sample inlet;
an ionization arrangement for ionizing molecules of an analyte substance entering the detection apparatus via the sample inlet into analyte ions;
an asymmetric field region in which the analyte ions are subject to an asymmetric field for detection; and
an arrangement for admitting at least one chemical additive to a location intermediate the ends of the asymmetric field region.

11. A detection apparatus as defined in claim 10, wherein the asymmetric field region has two parallel plate arrangements extending parallel to the ion flow direction, and wherein the arrangement for admitting the chemical additive comprises:
an opening through at least one of the plate arrangements intermediate the ends of the at least one of the plate arrangements.

12. A detection apparatus comprising:
a housing having a first end and an opposite second end, said second end being located downstream from said first end;
a sample inlet located in said housing at said first end;
an ionization arrangement located in said housing proximate said first end in which molecules of an analyte substance entering said housing through said sample inlet are ionized into analyte ions;
an asymmetric field region located downstream from said ionization source, wherein said analyte ions passing through said asymmetric field region are separated into different ion species with a first plurality of ion species being neutralized and a second plurality of ion species continuing downstream from said asymmetric field region toward said second end of said housing;
apparatus admitting at least one chemical additive at a plurality of different locations associated with the detection apparatus such that the analyte substance is subject to different ion chemistries at different locations in the apparatus; and
a detector located in said housing proximate said second end which detects said second plurality of ion species.

13. A detection apparatus as defined in claim 12, wherein said asymmetric field region is established by a pair of closely-spaced-apart FAIMS plates extending parallel to an axis extending downstream of said ionization arrangement and upstream of said second end of said housing.

14. A detection apparatus as defined in claim 13, additionally comprising:
a voltage source that is arranged to apply an asymmetric alternating voltage superimposed on a DC compensation voltage across said pair of FAIMS plates, said DC compensation voltage being selected such that said first plurality of ion species are attracted to one or other of said pair of FAIMS plates where they are neutralized.

15. A detection apparatus as defined in claim 12, additionally comprising:
a membrane covering said sample inlet, said membrane allowing molecules of an analyte of interest to enter said housing, but preventing larger molecules, particles, and the like from entering said housing.

16. A detection apparatus as defined in claim 12, additionally comprising:
an electrostatic gate located in said housing intermediate said ionization arrangement and said asymmetric field region, said electrostatic gate being operated to control the passage of analyte ions from said ionization arrangement to said asymmetric field region.

17. A detection apparatus as defined in claim 12, additionally comprising:
a processor operatively connected to said detector and to said chemical additive admitting apparatus;
wherein said detector comprises:
a detector plate at said second end of said housing, said detector plate collecting ions passing to said second end of said housing and providing an output to said processor indicative of ions detected by said detector plate.

18. A detection apparatus as defined in claim 12, additionally comprising:
a source of dry gas which is supplied to said housing at a location intermediate said ionization arrangement and said asymmetric field region and is exhausted from said detection apparatus at said second end of said housing.

19. A detection apparatus as defined in claim 12, wherein the at least one chemical additive is added at at least two of the locations in the detection apparatus from the group consisting of:
a location at said sample inlet;
a location intermediate said sample inlet and said ionization arrangement;
a location intermediate said ionization arrangement and said asymmetric field region;
a location intermediate opposite ends of said asymmetric field region; and
a location intermediate said asymmetric field region and said detector.

20. A detection apparatus as defined in claim 12, wherein the at least one chemical additive admitted at the plurality of different locations comprises a plurality of different substances.

21. A detection apparatus as defined in claim 12, wherein the at least one chemical additive admitted at the different locations comprises at least two chemical additives of different concentrations.

22. A detection apparatus as defined in claim 12, wherein the chemical additive comprises a dopant.

23. A detection apparatus as defined in claim 22, wherein said dopant comprises:
at least one of the dopant chemicals from the group consisting of ammonia, acetone, methanol, benzene, toluene, chlorine compounds such as dichloromethane, or bromine compounds such as dibromomethane.
